(19) United States
(12) Patent Application Publication
(10) Pub. No.: US 2026/0039226 A1
(43) Pub. Date: Feb. 5, 2026

(54) Power Conversion Device and Drive Device

(71) Applicant: Hitachi Astemo, Ltd., Hitachinaka-shi, Ibaraki (JP)

(72) Inventors: Ryoichi INADA, Tokyo (JP); Hiroshi NAKANO, Tokyo (JP); Nobuyasu KANEKAWA, Tokyo (JP); Satoru SHIGETA, Hitachinaka-shi, Ibaraki (JP); Yasuo SUGURE, Hitachinaka-shi, Ibaraki (JP)

(21) Appl. No.: 18/995,278

(22) PCT Filed: Jul. 19, 2023
(86) PCT No.: PCT/JP2023/026473

§ 371 Date: Jan. 16, 2025

(30) Foreign Application Priority Data
Sep. 14, 2022 (JP) 2022-146477

(51) Int. Cl. H02M 7/539; H02M 1/00

(52) U.S. Cl. CPC H02M 7/539; H02M 1/0009

(57) ABSTRACT

A power conversion device that converts DC power into three-phase AC power and outputs the three-phase AC power includes: an AC current sensor that detects two-phase current values among three-phase AC currents generated by the three-phase AC power; a target current calculation unit that calculates a target current based on a target torque; a voltage command calculation unit that calculates a voltage command value based on the target current and a detection value of the AC current sensor; and an AC current sensor diagnosis unit that determines abnormality of the AC current sensor based on a detection value of the AC current sensor. The AC current sensor diagnosis unit includes: a first diagnosis unit that determines the abnormality based on a two-phase voltage command value obtained by converting the voltage command value into a value in a two-phase orthogonal coordinate system with any output phase as a reference; and a second diagnosis unit that determines the abnormality based on a two-phase current detection value obtained by converting a detection value of the AC current sensor into a value in the two-phase orthogonal coordinate system. The AC current sensor diagnosis unit performs switching of determination between the determination of the abnormality by the first diagnosis unit and the determination of the abnormality by the second diagnosis unit corresponding to an operation condition of the power conversion device.

### TECHNICAL FIELD

The present invention relates to a power conversion device and a drive device.

### BACKGROUND ART

Conventionally, in a power conversion device (inverter) that converts DC power into AC power, supplies the AC power to an AC motor, and drives the AC motor, an AC current sensor is disposed. The AC current sensor detects an AC current outputted from the power conversion device to the AC motor. When a failure occurs in the AC current sensor, an output current of the power conversion device cannot be accurately controlled and hence, there is a concern that a motor output torque is excessively increased. Accordingly, it is necessary to diagnose the failure in the AC current sensor.

With respect to the diagnosis of a failure in an AC current sensor, for example, techniques disclosed in PTLs 1 and 2 are known. PTL 1 describes an invention relating to a motor control device that diagnoses a failure in an AC current sensor using a sum of three-phase AC current values. PTL 2 describes an invention relating to a motor control device that detects a failure in various sensors and detection circuits using a deviation between a command value and a predicted value of a d-axis voltage and a deviation between a command value and a predicted value of a q-axis voltage.

### CITATION LIST

### Patent Literatures

PTL 1: JP 2009-131043 A
PTL 2: JP 2017-127121 A

### SUMMARY OF INVENTION

### Technical Problem

In a power conversion device that supplies three-phase AC power to a motor, it is sufficient to detect AC currents for at least 2 phases by AC current sensors, and an AC current for the remaining 1 phase can be calculated because the sum of the 3-phase AC currents is zero. Accordingly, in order to perform a control of the power conversion device, it is sufficient to install the AC current sensor in only 2 phases respectively. However, in order to use the diagnosis method described in PTL 1, it is necessary to install an AC current sensor in all 3 phases. Accordingly, there is a concern that a manufacturing cost of the power conversion device is increased compared with the case where the AC current sensor is installed only in 2 phases.

On the other hand, a diagnostic method described in PTL 2 can be applied also to a configuration where an AC current sensor is installed in only 2 phases. However, there is a concern that a failure in the AC current sensor cannot be accurately detected under a motor operation condition where a deviation between a command value and a predicted value of a voltage hardly occurs.

The present invention has been made in view of the above problems, and it is a main object of the present invention is to realize a power conversion device and a drive device capable of accurately detecting a failure in an AC current sensor under an arbitrary motor operation condition without installing the AC current sensor in all 3 phases.

### Solution to Problem

A power conversion device according to the present invention is provided for converting DC power into three-phase AC power. The power conversion device includes: an AC current sensor that detects current values of 2 phases among three-phase AC currents generated by the three-phase AC power; a target current calculation unit that calculates a target current based on a target torque; a voltage command calculation unit that calculates a voltage command value based on the target current and a detection value of the AC current sensor; and an AC current sensor diagnosis unit that determines an abnormality of the AC current sensor based on a detection value of the AC current sensor, wherein the AC current sensor diagnosis unit includes: a first diagnosis unit that determines the abnormality based on a two-phase voltage command value obtained by converting the voltage command value into a value in a two-phase orthogonal coordinate system using any output phase as a reference; and a second diagnosis unit that determines the abnormality based on a two-phase current detection value obtained by converting a detection value of the AC current sensor into a value in the two-phase orthogonal coordinate system, and the AC current sensor diagnosis unit performs switching of determination between determination of the abnormality by the first diagnosis unit and determination of the abnormality by the second diagnosis unit corresponding to an operation condition of the power conversion device.

A drive device according to the present invention includes: a power conversion device; and an AC motor driven by a three-phase AC current outputted from the power conversion device, wherein a drive device drives a vehicle to travel using a driving force of the AC motor.

### Advantageous Effects of Invention

According to the present invention, it is possible to realize a power conversion device and a drive device capable of accurately detecting a failure occurred in an AC current sensor under an arbitrary motor operation condition without installing an AC current sensor in all 3 phases.

### BRIEF DESCRIPTION OF DRAWINGS

FIG. 1 is a view illustrating a vehicle on which a drive device according to an embodiment of the present invention is mounted.

FIG. 2 is a block diagram illustrating a configurational example of a power conversion device and the drive device according to the embodiment of the present invention.

FIG. 3 is a circuit diagram illustrating the configurational example of a power conversion circuit and a motor.

FIG. 4 is a flowchart illustrating an example of determination switching processing between a first diagnosis unit and a second diagnosis unit according to the first embodiment of the present invention.

FIG. 5 is a flowchart illustrating an example of abnormality diagnosis processing of the first diagnosis unit according to the first embodiment of the present invention.

FIG. 6 is a flowchart illustrating an example of abnormality diagnosis processing of the second diagnosis unit according to the first embodiment of the present invention.

FIG. 7 is a diagram illustrating an example of a two-phase voltage command value and a two-phase current detection value when a failure occurs in an AC current sensor according to the first embodiment of the present invention.

FIG. 8 is a flowchart illustrating an example of abnormality diagnosis processing of a first diagnosis unit according to a second embodiment of the present invention.

FIG. 9 is a flowchart illustrating an example of abnormality diagnosis processing of a second diagnosis unit according to the second embodiment of the present invention.

FIG. 10 is a flowchart illustrating an example of determination switching processing between a first diagnosis unit and a second diagnosis unit in a third embodiment of the present invention.

FIG. 11 is a flowchart illustrating an example of determination switching processing between a first diagnosis unit and a second diagnosis unit according to a fourth embodiment of the present invention.

### DESCRIPTION OF EMBODIMENTS

Hereinafter, embodiments of the present invention will be described. In each of the following embodiments, an example will be described where, in a power conversion device that converts DC power into three-phase AC power and outputs the converted three-phase AC power to a motor, an AC current sensor is installed only in 2 phases in three-phase AC currents flowing in the motor, and when a failure occurs in either one of the AC current sensors, the failure can be accurately detected.

### First Embodiment

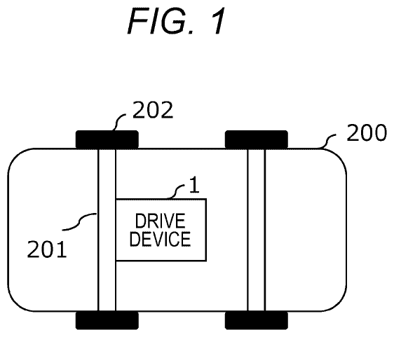

FIG. 1 is a view illustrating a vehicle on which a drive device according to an embodiment of the present invention is mounted. A drive device 1 mounted on a vehicle 200 is connected to an axle 201 of the vehicle 200. The drive device 1 includes a power conversion device, a motor, and a decelerator therein. The drive device 1 generates a driving force by controlling the power conversion device and the motor in response to an operation of the of an accelerator pedal performed by a driver, and transmits the driving force to the axle 201 by way of the decelerator, so that drive wheels 202 mounted on both ends of the axle 201 are rotated so as to make the vehicle 200 travel. The decelerator has a function of increasing a driving force of the motor and transmits the increased driving force to the axle 201.

In FIG. 1, the drive device 1 is connected to the axle 201 of the front wheels by using the front wheels of the vehicle 200 as the drive wheels 202. However, the drive device 1 may be connected to the axle of the rear wheels by using the rear wheels as the drive wheels. Alternatively, the drive device 1 may be connected to the axles of the front and rear wheels respectively, or the independent drive device 1 may be connected to each of the left and right wheels instead of connecting the drive device 1 to the axle.

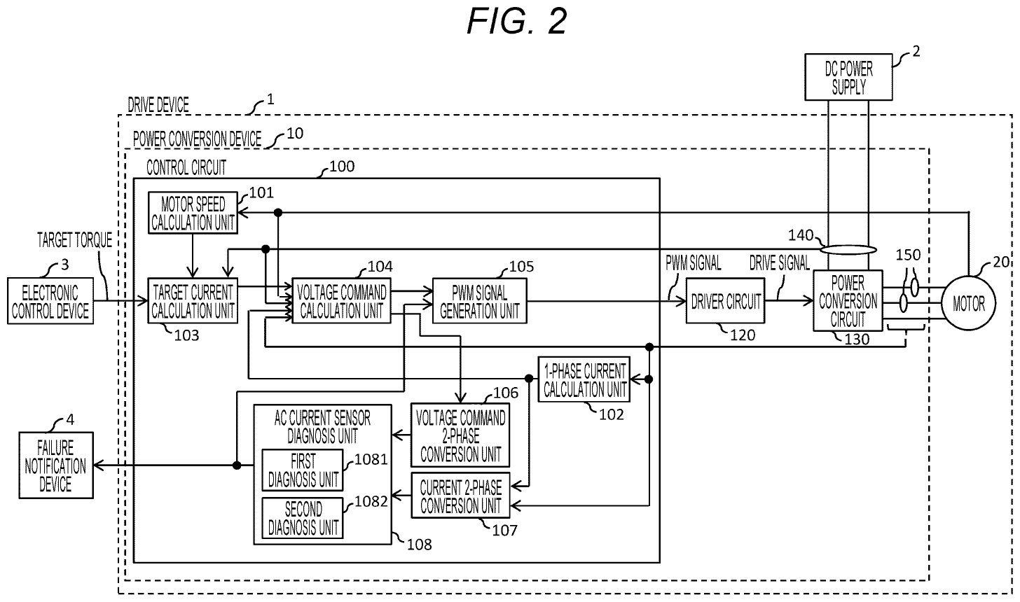

FIG. 2 is a block diagram illustrating a configurational example of a power conversion device and a drive device according to the embodiment of the present invention. The drive device 1 is connected to the DC power supply 2, the electronic control device 3, and the failure notification device 4 mounted on the vehicle 200 respectively illustrated in FIG. 1. The drive device 1 includes a power conversion device 10 and a motor 20.

The DC power supply 2 supplies DC power to the power conversion device 10 in the drive device 1. The DC power supplied from the DC power supply 2 is converted into three-phase AC power by the power conversion device 10 and outputs the three-phase AC power to the motor 20 from the power conversion device 10, thus driving the motor 20. A driving force of the motor 20 is transmitted to the axle 201 of the vehicle 200 by way of a decelerator (not illustrated in the drawings) as described above, whereby the vehicle 200 travels. The DC power supply 2 is configured using, for example, a secondary battery such as a lithium ion battery.

The electronic control device 3 transmits information such as a target torque to the drive device 1 in response to a driving operation or the like of the driver. The information of the target torque transmitted from the electronic control device 3 is inputted to a control circuit 100 in the power conversion device 10 in the drive device 1.

The failure notification device 4 receives a failure notification signal from the drive device 1 and notifies the passenger of the vehicle 200 of the occurrence of a failure. As examples of the failure notification method, a method of turning on a lamp, a method of generating a warning sound, and a method of notifying by voice and the like are named.

The motor 20 is a three-phase AC motor having windings for 3 phases therein, and may be, for example, a synchronous motor using a permanent magnet, or an induction motor that does not use a permanent magnet. An angle sensor (not illustrated in the drawings) for measuring a rotor rotation angle in the motor 20, that is, an electric angle of the motor 20 is mounted on the motor 20. The angle sensor outputs the measured electrical angle to the power conversion device 10 as an angle sensor value. The angle sensor of the motor 20 is constituted of a resolver or the like, for example.

The power conversion device 10 converts DC power obtained from the DC power supply 2 into three-phase AC power, and outputs the three-phase AC power to the motor 20 so as to drive the motor 20. The power conversion device 10 may also have a function of converting AC power generated by the motor 20 into DC power and charging DC power to the DC power supply 2. The power conversion device 10 includes the control circuit 100, a driver circuit 120, a power conversion circuit 130, a voltage sensor 140, and an AC current sensor 150. Further, the power conversion device 10 may include: a circuit breaker (not illustrated in the drawings) for cutting off DC power supplied from the DC power supply 2; and a circuit breaker drive circuit (not illustrated in the drawings) for driving the circuit breaker.

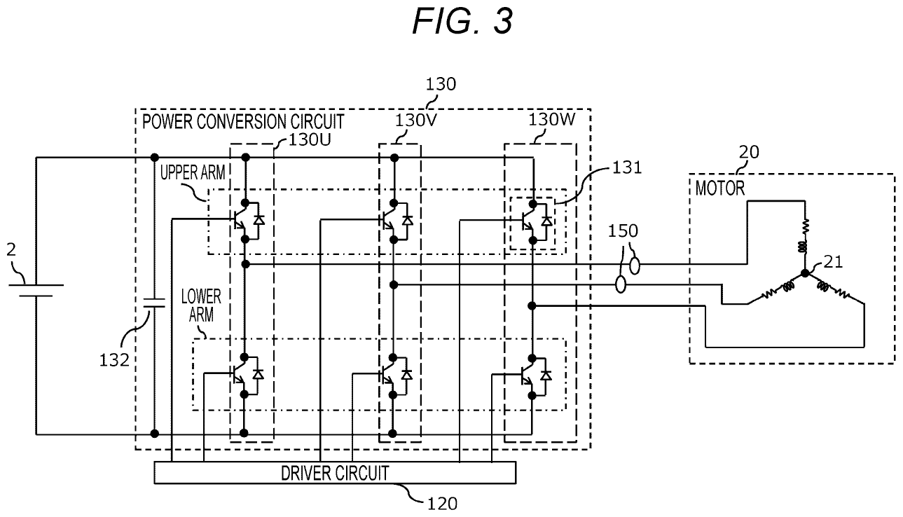

The power conversion circuit 130 receives a drive signal from the driver circuit 120, and drives an internal power semiconductor so as to control a current flowing into the motor 20. The internal configuration of the power conversion circuit 130 will be described hereinafter with reference to FIG. 3.

FIG. 3 is a circuit diagram illustrating the configurational example of the power conversion circuit 130 and the motor 20. The power conversion circuit 130 includes six power semiconductors 131 and a smoothing capacitor 132 therein.

Each power semiconductor 131 is switched ON/OFF in response to a drive signal inputted from the driver circuit 120. Each power semiconductor 131 is connected to the DC power supply 2 and the motor 20, and converts DC power and AC power between the DC power supply 2 and the motor 20 by an ON/OFF switching operation in response to a drive signal. As the power semiconductor 131, for example, a power metal oxide semiconductor field effect transistor (MOSFET), an insulated gate bipolar transistor (IGBT), or the like is used. In the embodiment described hereinafter, an example in which an IGBT is used as the power semiconductor 131 will be described. However, the same applies to a case where other semiconductor elements such as a power MOSFET is used.

In the power conversion circuit 130, six power semiconductors 131 are divided into two sides, that is, an upper side and a lower side for respective phases. Outputs from the pairs of power semiconductors 131 of respective phases are connected to the windings of the respective phases of the motor 20.

In the present embodiment, three power semiconductors 131 on the upper side in FIG. 3 are collectively referred to as an upper arm, and the lower three power semiconductors 131 in FIG. 3 are collectively referred to as a lower arm. That is, the power conversion circuit 130 includes 3 sets of series circuits each formed of the upper arm and the lower arm, and these series circuits are connected to windings of the respective phases of the motor 20 as a leg 130U that corresponds to a U-phase, a leg 130V that corresponds to a V-phase, and a leg 130W that corresponds to a W phase.

The smoothing capacitor 132 is a capacitor for smoothing current fluctuation caused by turning ON/OFF of each power semiconductor 131 and for suppressing a ripple of a DC current supplied from the DC power supply 2 to the power conversion circuit 130. As the smoothing capacitor 132, for example, an electrolytic capacitor or a film capacitor is used.

In the present embodiment, a motor neutral point 21 to which the windings of the respective phases of the motor 20 are connected is in a floating state. However, the motor neutral point 21 may be connected to ground (not illustrated in the drawings) of the power conversion device 10. As a method for connecting the motor neutral point 21 to the ground, there are a direct grounding method, a resistance grounding method, a compensation reactor grounding method, an arc-extinguishing reactor grounding method, and the like are named. Any method can be used.

Returning to FIG. 2, the description of the present embodiment is described. The voltage sensor 140 is a sensor that measures an output voltage of the DC power supply 2, and is connected between the DC power supply 2 and the power conversion circuit 130. The voltage sensor 140 outputs a measured voltage value to the control circuit 100 as a voltage sensor value.

AC current sensors 150 are sensors that measure AC currents for 2 phases of a three-phase AC current outputted from the power conversion circuit 130 to the motor 20, and are connected between the power conversion circuit 130 and the motor 20. The AC current sensors 150 output the measured 2-phase current values to the control circuit 100 as AC current sensor values.

In the example illustrated in FIG. 2, the AC current sensor 150 is installed in the U-phase and the V-phase, but the phase in which the AC current sensor 150 is installed is not necessarily limited to these 2 phases. In the present embodiment, a current that flows from the power conversion circuit 130 toward the motor 20 is treated as a positive current, and a current that flows from the motor 20 toward the power conversion circuit 130 is treated as a negative current.

The driver circuit 120 receives a pulse width modulation (PWM) signal that the control circuit 100 outputs, generates drive signals for switching on/off respective power semiconductors 131 of the power conversion circuit 130, and outputs the drive signals to the power conversion circuit 130.

The control circuit 100 performs communication with the electronic control device 3, and receives a target torque of the motor 20 from the electronic control device 3. Based on this target torque, the control circuit 100 controls PWM signals so as to control currents in the respective phases outputted from the power conversion device 10 to the motor 20 to predetermined values, and outputs the controlled PWM signals to the driver circuit 120. The power conversion circuit 130 is driven by drive signals outputted from the driver circuit 120 corresponding to the PWM signals and hence, the control circuit 100 can drive the power conversion circuit 130 via the driver circuit 120.

Further, the control circuit 100 diagnoses whether or not a failure has occurred in the power conversion device 10, and outputs a failure notification signal to the failure notification device 4 when it is determined that a failure has occurred. With such processing, the failure notification device 4 performs the failure notification described above to a passenger on the vehicle 200 and hence, it is possible to notify the passenger of the occurrence of the failure.

The control circuit 100 includes respective functional blocks constituted of: a motor speed calculation unit 101; a 1-phase current calculation unit 102; a target current calculation unit 103; a voltage command calculation unit 104; a PWM signal generation unit 105; a voltage command 2-phase conversion unit 106; a current 2-phase conversion unit 107; and an AC current sensor diagnosis unit 108. The control circuit 100 includes a central processing unit (CPU), a random access memory (RAM), a read only memory (ROM), a communication circuit and the like (none of them illustrated in the drawing). The control circuit 100 can implement functions represented by the functional blocks described above by allowing the CPU to execute predetermined programs stored in the ROM. The ROM of the control circuit 100 may be an electrically rewritable such as an electrically erasable programmable ROM (EEPROM) or a flash ROM.

The motor speed calculation unit 101 acquires an angle sensor value outputted from an angle sensor disposed in the motor 20, and calculates a rotational speed of the motor 20 from a change with time of the angle sensor value. Then, the calculated rotational speed of the motor 20 is outputted to the target current calculation unit 103 as a motor speed value.

The 1-phase current calculation unit 102 acquires 2-phase AC current sensor values outputted from the AC current sensors 150, and calculates an AC current value of the remaining 1 phase that is not yet measured from the relationship expressed by a U-phase current+a V-phase current+a W-phase current=0. Then, the calculated AC current value for 1 phase is outputted to the voltage command calculation unit 104 and the current 2-phase conversion unit 107.

The target current calculation unit 103 calculates, using the target torque transmitted from the electronic control device 3, a voltage sensor value outputted from the voltage sensor 140, and a motor speed value outputted from the motor speed calculation unit 101, a current value to be supplied to the motor 20 for allowing the motor 20 to output the same torque as a target torque. Then, the calculated current value is outputted to the voltage command calculation unit 104 as a target current. The target current is expressed as values in a 2-phase orthogonal coordinate system, such as a d-axis target current value and a q-axis target current value.

The voltage command calculation unit 104 calculates 3-phase voltage command values to be outputted to the motor 20 based on the target current outputted from the target current calculation unit 103 and the 2-phase AC current sensor values outputted from the AC current sensors 150. At this stage of processing, the voltage command calculation unit 104 calculates the 3-phase voltage command values, using an angle sensor value outputted from an angle sensor in the motor 20, by performing a feedback control such that the 2-phase AC current sensor values and an AC current value for a remaining 1 phase outputted from the 1-phase current calculation unit 102 follow the target current respectively. Further, the duty values of the respective phases are calculated based on the calculated voltage command values of the 3 phases. Then, the calculated duty values are outputted to the PWM signal generation unit 105, and the voltage command values of 3 phases are outputted to the voltage command 2-phase conversion unit 106.

The PWM signal generation unit 105 generates PWM signals for the respective power semiconductors 131 in the power conversion circuit 130 using the duty values of the respective phases outputted from the voltage command calculation unit 104, and outputs the PWM signals to the driver circuit 120. The PWM signal generation unit 105 includes a timer (not illustrated in the drawings) therein, and generates a timer value that continuously changes at regular time intervals using the timer. Then, the PWM signals can be generated based on the generated timer value and the duty values of the respective phases.

The PWM signal generation unit 105 switches a signal to be outputted to the driver circuit 120 in response to the failure notification information outputted from the AC current sensor diagnosis unit 108. More specifically, in a case where the failure notification information indicating that the AC current sensor 150 is abnormal is not outputted from the AC current sensor diagnosis unit 108, the PWM signal generation unit 105 generates PWM signals based on the duty values of respective phases as described above, and outputs the PWM signals to the driver circuit 120. On the other hand, in a case where the failure notification information indicating that the AC current sensor 150 is abnormal is outputted from the AC current sensor diagnosis unit 108, the PWM signal generation unit 105 generates a PWM signal that brings the motor 20 into a non-driving state regardless of the duty values of the respective phases, and outputs the PWM signal to the driver circuit 120. As the non-driving state of the motor 20, for example, a state where all six power semiconductors 131 that the power conversion circuit 130 includes are turned off, a state where all power semiconductors 131 in the upper arm out of six power semiconductors 131 are turned on and all power semiconductors 131 in the lower arm are turned off out of six power semiconductors 131, a state where all power semiconductors 131 in the upper arm are turned off out of six power semiconductors 131 and all power semiconductors 131 in the lower arm are turned on out of six power semiconductors 131, and the like are named.

The voltage command 2-phase conversion unit 106 applies 2-phase conversion to voltage command values of 3 phases outputted from the voltage command calculation unit 104. In this manner, the voltage command 2-phase conversion unit 106 calculates a two-phase voltage command value that express these voltage command values of three phases by values of a 2-phase orthogonal coordinate system using any one of 3 phases as a reference. As a method of 2-phase conversion performed in this processing, for example, the αβ conversion, the dq conversion and the like can be named. Then, the calculated two-phase voltage command values are outputted to the AC current sensor diagnosis unit 108.

A case is considered where, in the voltage command calculation unit 104, 3-phase AC current values are converted into d-axis current values and q-axis current values, differentials between these d-axis current values and q-axis current values and d-axis target current values and q-axis target current values are respectively calculated thus obtaining two-phase voltage command values, two-phase voltage command values are obtained from the two-phase current command values, and two-phase voltage command values are converted into 3-phase voltage command values. In this case, by outputting the two-phase voltage command values from the voltage command calculation unit 104 to the AC current sensor diagnosis unit 108, the voltage command 2-phase conversion unit 106 may be omitted.

The current 2-phase conversion unit 107 applies 2-phase conversion to the 2-phase AC current sensor values outputted from the AC current sensor 150 and the remaining 1-phase AC current value outputted from the 1-phase current calculation unit 102 thus calculating two-phase current detection values expressed by values of 2-phase orthogonal coordinate system using any one of these 3-phase AC current values as a reference. As a method of 2-phase conversion performed in this processing, for example, the αβ conversion, the dq conversion and the like can be named in the same manner as the voltage command 2-phase conversion unit 106. Then, the calculated two-phase current detection values are outputted to the AC current sensor diagnosis unit 108.

When the voltage command calculation unit 104 calculates a voltage command value by obtaining a two-phase voltage command value from a two-phase current command value obtained by converting a 3-phase AC current value into a d-axis current value and a q-axis current value and by calculating a differential between a d-axis target current value and a q-axis target current value as described above and by converting the two-phase voltage command value into the 3-phase voltage command value, the current 2-phase conversion unit 107 may be omitted by outputting the d-axis current value and the q-axis current value from the voltage command calculation unit 104 to the AC current sensor diagnosis unit 108.

The AC current sensor diagnosis unit 108 determines occurrence of abnormality in the AC current sensor 150 based on an AC current sensor value outputted from the AC current sensor 150. In the abnormality determination, the AC current sensor diagnosis unit 108 performs the failure determination of the AC current sensor 150 using a two-phase voltage command value outputted from the voltage command 2-phase conversion unit 106 and a two-phase current detection value outputted from the current 2-phase conversion unit 107 based on an AC current sensor value, and outputs the failure notification information corresponding to the determination result. The failure notification information outputted from the AC current sensor diagnosis unit 108 includes, for example, information “no failure” when the AC current sensor 150 is normal, and information “failure in AC current sensor” when a failure occurred in the AC current sensor 150 is detected.

The AC current sensor diagnosis unit 108 includes: a first diagnosis unit 1081 that performs abnormality determination based on a two-phase voltage command value outputted from the voltage command 2-phase conversion unit 106, and a second diagnosis unit 1082 that performs abnormality determination based on a two-phase current detection value outputted from the current 2-phase conversion unit 107. Then, the AC current sensor diagnosis unit 108 switches between the abnormality determination by the first diagnosis unit 1081 and the abnormality determination by the second diagnosis unit 1082 corresponding to the operation condition of the power conversion device 10. Such a processing will be described in detail hereinafter.

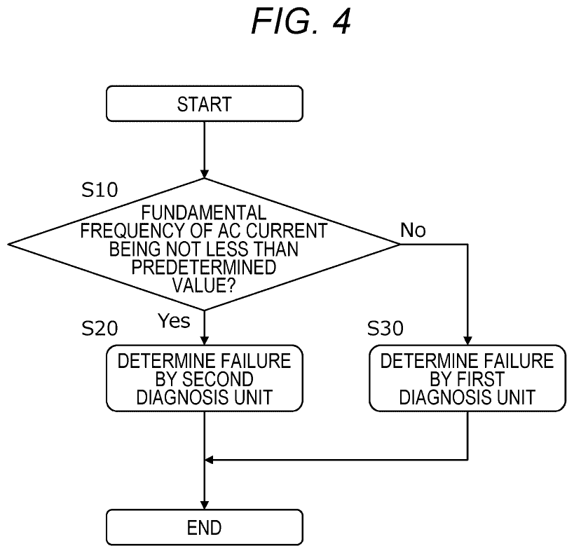

FIG. 4 is a flowchart illustrating an example of processing for switching the determination between the determination processing performed by the first diagnosis unit 1081 and the determination processing performed by the second diagnosis unit 1082 according to the first embodiment of the present invention. In the present embodiment, the AC current sensor diagnosis unit 108, by performing determination switching processing illustrated in the flowchart in FIG. 4, switches the abnormality determination between the abnormality determination performed by the first diagnosis unit 1081 and the abnormality determination performed by the second diagnosis unit 1082 corresponding to the operation condition of the power conversion device 10.

In step S10, the AC current sensor diagnosis unit 108 determines whether or not a fundamental frequency of three-phase AC currents flowing into the motor 20 is a predetermined value or more. In this embodiment, for example, the determination in step S10 can be performed in such a manner that the fundamental frequency of the three-phase AC current is calculated based on a motor speed value outputted from the motor speed calculation unit 101 and the calculation result is compared with a predetermined value.

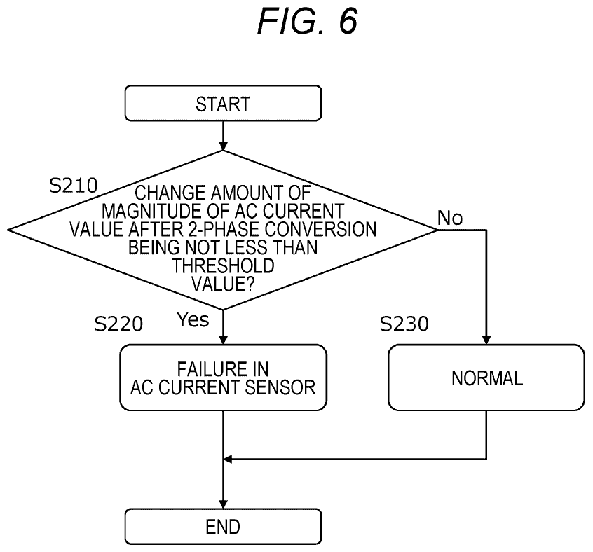

In the determination performed in step S10, in a case where it is determined that the fundamental frequency of the three-phase AC current is the predetermined value or more, processing advances to step S20, and abnormality determination is performed by the second diagnosis unit 1082. In this case, the second diagnosis unit 1082 determines whether or not the AC current sensor 150 is abnormal by performing processing in a flowchart illustrated in FIG. 6 described later. When the abnormality determination is performed by the second diagnosis unit 1082 in step S20, the processing illustrated in the flowchart in FIG. 4 ends.

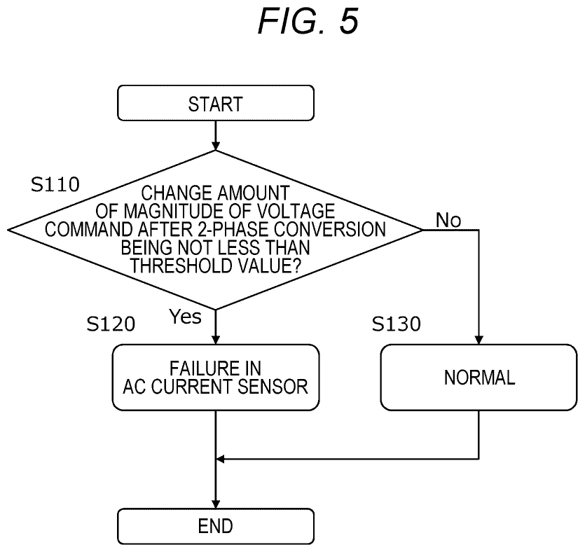

On the other hand, when it is determined in step S10 that the fundamental frequency of the three-phase AC currents is smaller than the predetermined value, the processing advances to step S30, and the first diagnosis unit 1081 performs abnormality determination. In this case, the first diagnosis unit 1081 determines whether or not the AC current sensor 150 is abnormal by performing processing in a flowchart illustrated in FIG. 5 described later. When the abnormality determination is performed by the first diagnosis unit 1081 in step S30, the processing in a flowchart illustrated in FIG. 4 ends.

FIG. 5 is a flowchart illustrating an example of abnormality diagnosis processing performed by the first diagnosis unit 1081 according to the first embodiment of the present invention.

In step S110, the first diagnosis unit 1081 detects a change amount of the magnitude of a two-phase voltage command value outputted from the voltage command 2-phase conversion unit 106, and determines whether or not the change amount is equal to or larger than a predetermined threshold. In this processing, for example, a d-axis voltage command value and a q-axis voltage command value are acquired from the voltage command 2-phase conversion unit 106 as a two-phase voltage command value. By expressing these values as a vector on a dq plane, a change with time of the magnitude of the vector is observed. Then, a change amount of two-phase voltage command value is obtained from a maximum value and a minimum value of the change amount with time of the vector. The determination in step S110 can be performed by comparing the change amount of the two-phase voltage command value obtained as described above with a predetermined threshold.

When it is determined in step S110 that the change amount of the magnitude of the two-phase voltage command value is equal to or larger than the threshold, the processing advances to step S120, and it is determined that a failure occurred in the AC current sensor 150. On the other hand, when it is determined that the change amount of the magnitude of the two-phase voltage command value is less than the threshold, the processing advances to step S130, and it is determined that the AC current sensor 150 is normal. After performing the processing in step S120 or S130, the first diagnosis unit 1081 outputs failure notification information according to the determination result, and ends the processing illustrated in the flowchart in FIG. 5.

FIG. 6 is a flowchart illustrating an example of abnormality diagnosis processing performed by the second diagnosis unit 1082 according to the first embodiment of the present invention.

In step S210, the second diagnosis unit 1082 detects a change amount of the magnitude of a two-phase current detection value outputted from the current 2-phase conversion unit 107, and determines whether or not the change amount is equal to or larger than a predetermined threshold. In this processing, for example, a d-axis current value and a q-axis current value are acquired from the current 2-phase conversion unit 107 as a two-phase current detection value, these values are expressed as a vector on a dq plane, a change with time of the magnitude of the vector is observed, and a change amount of the two-phase current detection value is obtained from a maximum value and a minimum values of the change amount with time of the magnitude of the vector. The determination in step S210 can be performed by comparing the change amounts of the two-phase current detection values that are obtained as described above with predetermined thresholds.

In the determination performed in step S210, when it is determined that the change amount of the magnitude of the two-phase current detection value is the threshold or more, the processing advances to step S220, and it is determined that a failure occurred in the AC current sensor 150. On the other hand, when it is determined that the change amount of the magnitude of the two-phase current detection value is less than the threshold, the processing advances to step S230, and it is determined that the AC current sensor 150 is normal. After performing the processing in step S220 or S230, the second diagnosis unit 1082 outputs failure notification information corresponding to the determination result, and ends the processing illustrated in the flowchart in FIG. 6.

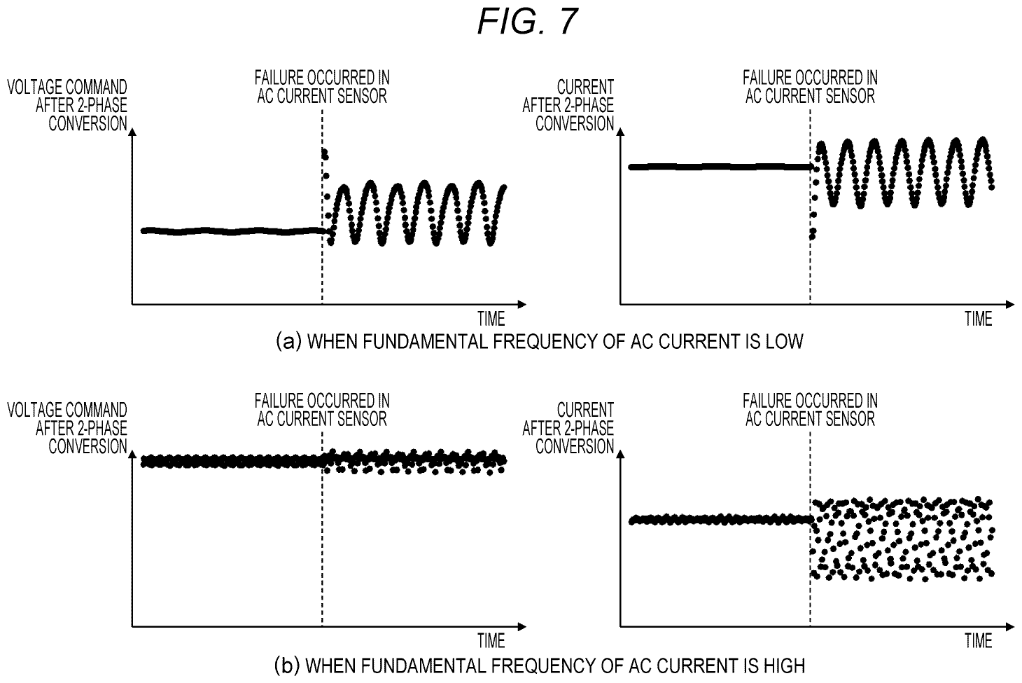

Next, a change in the two-phase voltage command value and a change in the two-phase current detection value when a failure occurred in the AC current sensor 150 will be described hereinafter with reference to a specific example illustrated in FIG. 7. FIG. 7 is a diagram illustrating an example of a two-phase voltage command value and a two-phase current detection value when a failure occurred in an AC current sensor according to the first embodiment of the present invention.

FIG. 7(a) in the upper part of the drawing that illustrates an example of a two-phase voltage command value and a two-phase current detection value in a case where a fundamental frequency of a three-phase AC current is lower than a predetermined value. In FIG. 7(a), the diagram on a left side represents a change with time of the two-phase voltage command value, and the diagram on a right side represents a change with time of the two-phase current detection value. In this case, when a failure occurred in the AC current sensor 150, the two-phase voltage command value and the two-phase current detection value greatly change respectively. Accordingly, it is understood that the first diagnosis unit 1081 can determine whether or not a failure occurred in the AC current sensor 150 from a change amount of the magnitude of a two-phase voltage command value.

FIG. 7(b) in the lower part of the drawing that illustrates an example of a two-phase voltage command value and a two-phase current detection value in a case where a fundamental frequency of a three-phase AC current is lower than a predetermined value. In FIG. 7(b), the diagram on a left side represents a change with time of the two-phase voltage command value, and the diagram on a right side represents a change with time of the two-phase current detection value. In this case, when a failure occurred in the AC current sensor 150, although the two-phase current detection value largely changes, the two-phase voltage command value does not change so much. Accordingly, it is understood that whether or not a failure occurred in the AC current sensor 150 cannot be determined by the first diagnosis unit 1081, and whether or not a failure occurred in the AC current sensor 150 can be determined by the second diagnosis unit 1082 from a change amount of the magnitude of the two-phase current detection value.

The above-mentioned difference between a change in a two-phase voltage command value and a change in a two-phase current detection value due to a fundamental frequency of a three-phase AC current is attributed to a current feedback control that the voltage command calculation unit 104 performs. Such a processing will be described in detail hereinafter.

The voltage command calculation unit 104 normally calculates a voltage command value using a PI control as a current feedback control. In this case, a differential between a target current and an actual current becomes a P control term, and a product obtained by accumulating differential each being between a target current and an actual current for every time becomes an I control term. Therefore, in a case where a failure occurred in the AC current sensor 150 when a change in a current is slow, that is, when a fundamental frequency of an AC current is low, in a state where a differential between a target current and an actual current is likely to be accumulated, the I control term acts strongly. Accordingly, the voltage command calculation unit 104 intends to more strongly correct the deviation between the target current to which an amount of error due to the failure occurred in the AC current sensor 150 is added and the actual current. As a result, while the magnitude of the two-phase voltage command value largely changes, a change amount of the magnitude of the two-phase current detection value becomes relatively small. On the other hand, when the change of the current is fast, that is, when the fundamental frequency of the AC current is high, the correction by the I control term does not work strongly. Accordingly, the magnitude of the two-phase voltage command value does not change so much, while the two-phase current detection value changes largely.

As described above, when a fundamental frequency of an AC current is low, a two-phase voltage command value largely changes. Accordingly, the abnormality determination based on the two-phase voltage command value performed by the first diagnosis unit 1081 can obtain a more accurate determination result than the abnormality determination based on the two-phase current detection value performed by the second diagnosis unit 1082. On the other hand, when a fundamental frequency of an AC current is high, an abnormality determination based on a two-phase current detection value performed by the second diagnosis unit 1082 can obtain a more accurate determination result than an abnormality determination based on a two-phase voltage command value performed by the first diagnosis unit 1081.

According to the first embodiment of the present invention described above, the following manner of operation and advantageous effects can be achieved.
(1) The power conversion device 10 converts DC power into three-phase AC power, and outputs the three-phase AC power. The power conversion device 10 includes: the AC current sensor 150 that detects current values of 2 phases among three-phase AC currents generated by the three-phase AC power; the target current calculation unit 103 that calculates a target current based on a target torque; the voltage command calculation unit 104 that calculates a voltage command value based on the target current and a detection value of the AC current sensor 150; and the AC current sensor diagnosis unit 108 that determines abnormality of the AC current sensor 150 based on a detection value of the AC current sensor 150. The AC current sensor diagnosis unit 108 includes: the first diagnosis unit 1081 that determines an abnormality of the AC current sensor 150 based on a two-phase voltage command value obtained by converting a voltage command value into a value in the two-phase orthogonal coordinate system using any output phase as a reference; and the second diagnosis unit 1082 that determines an abnormality of the AC current sensor 150 based on a two-phase current detection value obtained by converting a detection value of the AC current sensor 150 into a value in the two-phase orthogonal coordinate system. The AC current sensor diagnosis unit 108 switches the abnormality determination between the abnormality determination by the first diagnosis unit 1081 and the abnormality determination by the second diagnosis unit 1082 corresponding to the operation condition of the power conversion device 10. With such a configuration, it is possible to realize the power conversion device 10 capable of accurately detecting a failure occurred in the AC current sensor 150 under an arbitrary motor operation condition without installing the AC current sensor 150 in all three phases.
(2) In the AC current sensor diagnosis unit 108, when the fundamental frequency of the three-phase AC current is smaller than the predetermined value (step S10: No), the first diagnosis unit 1081 determines the abnormality of the AC current sensor 150 (step S30), and when the fundamental frequency of the three-phase AC current is equal to or larger than the predetermined value (step S10: Yes), the second diagnosis unit 1082 determines the abnormality of the AC current sensor 150 (step S20). With such a configuration, when a voltage command value is calculated using a PI control, an abnormality occurred in the AC current sensor 150 can be accurately detected regardless of a fundamental frequency of an AC current.
(3) In a case where a change amount of the magnitude of a two-phase voltage command value is equal to or larger than a predetermined threshold (step S110: Yes), the first diagnosis unit 1081 determines that an abnormality occurred in the AC current sensor 150 (step S120). With such a configuration, the first diagnosis unit 1081 can reliably detect that a failure occurred in the AC current sensor 150.
(4) In a case where a change amount of the magnitude of a two-phase current detection value is equal to or larger than a predetermined threshold (step S210: Yes), the second diagnosis unit 1082 determines that an abnormality occurred in the AC current sensor 150 (step S220). With such a configuration, the second diagnosis unit 1082 can reliably detect that a failure occurred in the AC current sensor 150.
(5) The drive device 1 includes: the power conversion device 10; and the AC motor 20 driven by a three-phase AC current outputted from the power conversion device 10, wherein a drive device 1 drives the vehicle 200 to travel using a driving force of the AC motor 20. With such a configuration, it is possible to realize the drive device 1 capable of accurately detecting a failure occurred in the AC current sensor 150 under an arbitrary motor operation condition without installing the AC current sensor 150 in all three phases in the power conversion device 10.

### Second Embodiment

Hereinafter, the second embodiment of the present invention will be described. In the present embodiment, the description is made with respect to an example of a power conversion device capable of determining the occurrence of a failure in the AC current sensor 150 in a shorter time. The description of configurational parts substantially equal to the corresponding configurational parts of the first embodiment will be omitted unless otherwise necessary.

In the present embodiment, a diagnosis method of the first diagnosis unit 1081 and a diagnostic method of the second diagnosis unit 1082 in the AC current sensor diagnosis unit 108 differ from the corresponding diagnosis methods in the first embodiment. In the present embodiment, the first diagnosis unit 1081 has a function of calculating a target value of a two-phase voltage command value and of performing abnormality determination of the AC current sensor 150 based on the target value. Further, the second diagnosis unit 1082 has a function of calculating a target value of a two-phase current detection value and of performing abnormality determination of the AC current sensor 150 based on the target value.

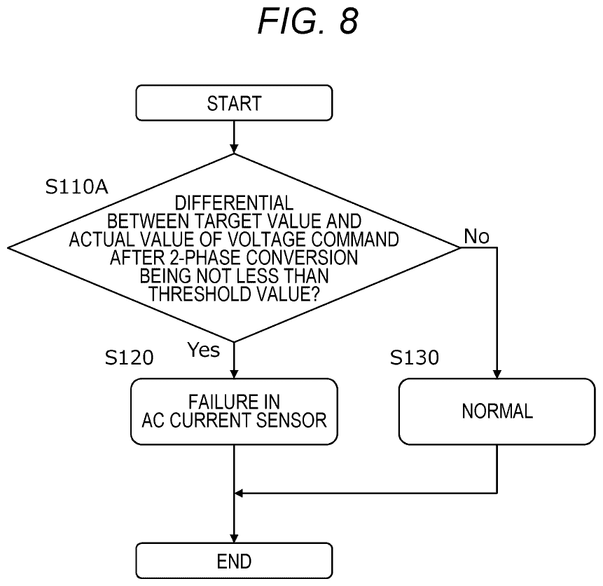

FIG. 8 is a flowchart illustrating an example of abnormality diagnosis processing performed by the first diagnosis unit 1081 according to the second embodiment of the present invention.

In step S110A, the first diagnosis unit 1081 acquires a target value for a two-phase voltage command value outputted from the voltage command 2-phase conversion unit 106, obtains a differential between the target value and the current two-phase voltage command value actually outputted from the voltage command 2-phase conversion unit 106, and determines whether or not the differential value is equal to or larger than a predetermined threshold. In this embodiment, for example, by acquiring a target current outputted from the target current calculation unit 103 and by calculating a target value for the two-phase voltage command value based on the value of the target current, the target value that corresponds to the two-phase voltage command value when the AC current sensor 150 is normal can be acquired, and the determination in step S110A can be performed.

When it is determined in step S110A that the differential between the target value and the actual value of the two-phase voltage command value is equal to or larger than a threshold, the processing advances to step S120, and it is determined that a failure occurred in the AC current sensor 150. On the other hand, when it is determined that the differential between the target value and the actual value of the two-phase voltage command value is less than the threshold, the processing advances to step S130, and it is determined that the AC current sensor 150 is normal. After performing the processing in step S120 or S130, the first diagnosis unit 1081 outputs failure notification information corresponding to the determination result, and ends the processing illustrated in the flowchart in FIG. 8.

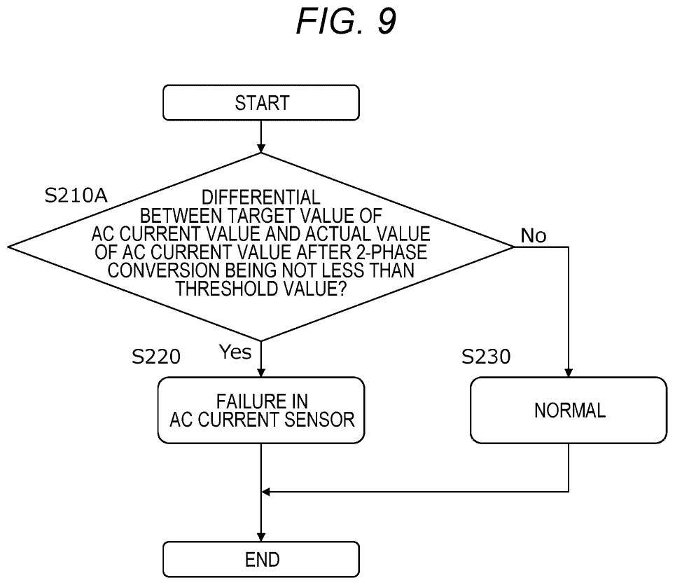

FIG. 9 is a flowchart illustrating an example of abnormality diagnosis processing performed by the second diagnosis unit 1082 according to the second embodiment of the present invention.

In step S210A, the second diagnosis unit 1082 acquires a target value for the two-phase current detection value outputted from the current 2-phase conversion unit 107, obtains a differential between the target value and a present two-phase current detection value actually outputted from the current 2-phase conversion unit 107, and determines whether or not the differential value is equal to or larger than a predetermined threshold. In this embodiment, for example, by acquiring a target current outputted from the target current calculation unit 103 and by setting a value of the target current as a target value for the two-phase current detection value, the target value corresponding to the two-phase current detection value when the AC current sensor 150 is normal can be acquired, and the determination in step S210A can be performed.

When it is determined in step S210A that a differential between the target value and an actual value of the two-phase current detection value is equal to or larger than a threshold, the processing advances to step S220, and it is determined that a failure occurred in the AC current sensor 150. On the other hand, when it is determined that the differential between the target value and the actual value of the two-phase current detection value is less than a threshold, the processing advances to step S230, and it is determined that the AC current sensor 150 is normal. After performing the processing in step S220 or S230, the second diagnosis unit 1082 outputs failure notification information corresponding to the determination result, and ends the processing illustrated in the flowchart in FIG. 9.

In the first embodiment described above, the first diagnosis unit 1081 has determined whether or not a failure occurred in the AC current sensor 150 using a change amount of a magnitude of a two-phase voltage command value outputted from the voltage command 2-phase conversion unit 106. Further, the second diagnosis unit 1082 has determined whether or not a failure occurred in the AC current sensor 150 using a change amount of a magnitude of a two-phase current detection value outputted from the current 2-phase conversion unit 107. In these determination methods, it takes time until the presence or non-presence of a change in each information is confirmed and hence, there exists a problem that a time necessary before the failure determination starts. On the other hand, in this embodiment, a target value and an actual value of a two-phase voltage command value or a two-phase current detection value are compared with each other. Accordingly, when a deviation occurred between these values along with the occurrence of a failure in the AC current sensor 150, the deviation can be readily determined. Accordingly, the failure determination in the second embodiment can be performed in a shorter time than the failure determination in the first embodiment.

According to the second embodiment of the present invention described above, the first diagnosis unit 1081 acquires a target value for a two-phase voltage command (step S110A), and when a differential between the target value and an actual two-phase voltage command value is equal to or larger than a predetermined threshold (step S110A: Yes), the first diagnosis unit 1081 determines that the AC current sensor 150 is abnormal (step S120). The second diagnosis unit 1082 acquires a target value for a two-phase current detection value (step S210A), and when a differential between the target value and an actual two-phase current detection value is equal to or larger than a predetermined threshold (step S210A: Yes), the second diagnosis unit 1082 determines that the AC current sensor 150 is abnormal (step S220). With such a configuration, the failure determination of the AC current sensor 150 can be performed in a shorter time in each of the first diagnosis unit 1081 and the second diagnosis unit 1082.

### Third Embodiment

Hereinafter, the third embodiment of the present invention will be described. In this embodiment, description is made with respect to an example of a power conversion device that performs determination switching processing between the first diagnosis unit 1081 and the second diagnosis unit 1082 based on an operation condition that differs from the operation condition in the first embodiment. The description of configurational parts substantially equal to the corresponding configurational parts of the first embodiment will be omitted unless otherwise necessary.

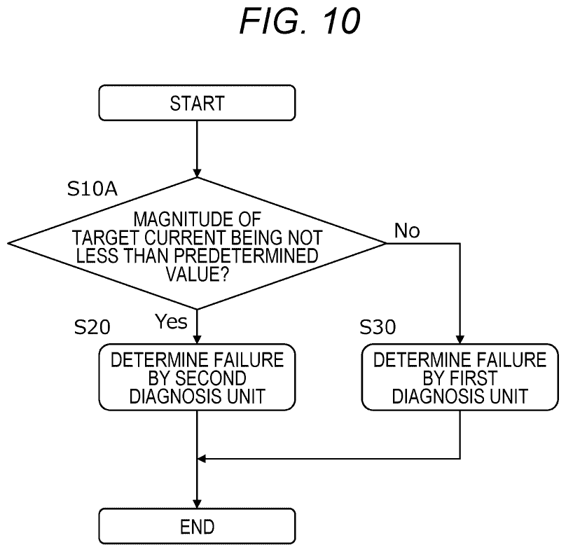

FIG. 10 is a flowchart illustrating an example of determination switching processing between the first diagnosis unit 1081 and the second diagnosis unit 1082 in the third embodiment of the present invention.

In step S10A, the AC current sensor diagnosis unit 108 determines whether or not a magnitude of a target current for the motor 20 is equal to or larger than a predetermined value. In this embodiment, for example, a target current outputted from the target current calculation unit 103 is acquired, and the determination in step S10A can be performed using a value of this target current.

In the determination performed in step S10A, in a case where it is determined that a magnitude of a target current is equal to or larger than a predetermined value, the processing advances to step S20, and abnormality determination is performed by the second diagnosis unit 1082. On the other hand, when it is determined in step S10A that the magnitude of the target current is smaller than the predetermined value, the processing advances to step S30, and the abnormality determination is performed by the first diagnosis unit 1081. When the abnormality determination is performed by either one of the first diagnosis unit 1081 or the second diagnosis unit 1082 in step S20, S30, the processing illustrated in the flowchart in FIG. 10 ends.

As has been described in the first embodiment, when a force of a current correction by a current feedback control is strong, the first diagnosis unit 1081 can more easily determine the occurrence of a failure in the AC current sensor 150 than the second diagnosis unit 1082. Conversely, when the force of the current correction by the current feedback control is weak, the second diagnosis unit 1082 can more easily determine the occurrence of a failure in the AC current sensor 150 than the first diagnosis unit 1081. With respect to a P control term and an I control term in a current feedback control in the voltage command calculation unit 104, the larger a differential between a target current and an actual current, the more strongly the corrections made by both of these controls act. In this embodiment, in a case where an actual current deviates from a target current by a certain amount due to a failure occurred in the AC current sensor 150, when a target current is small, a differential between the actual current and the target current becomes large and hence, the correction of a control performed by the voltage command calculation unit 104 becomes strong. Accordingly, an effect caused due to the occurrence of a failure in the AC current sensor 150 becomes relatively large. Conversely, when the target current is large, a differential between the actual current and the target current becomes small and hence, the correction of the control performed by the voltage command calculation unit 104 becomes weak. Accordingly, an effect caused due to the occurrence of a failure becomes relatively small.

As described above, when a target current is small, the correction of a control by the voltage command calculation unit 104 is strong. Accordingly, in this case, the abnormality determination based on a two-phase voltage command value that is performed by the first diagnosis unit 1081 can more easily obtain an accurate determination result. On the other hand, when a target current is large, the correction of a control by the voltage command calculation unit 104 is weak. Accordingly, the abnormality determination based on a two-phase current detection value performed by the second diagnosis unit 1082 can more easily obtain an accurate determination result. Accordingly, even when a failure determination method is switched using a target current instead of a fundamental frequency of an AC current as in the present embodiment, the occurrence of a failure in the AC current sensor 150 can be accurately determined.

According to the third embodiment of the present invention described above, when a target current is smaller than a predetermined value (step S10A: No), the AC current sensor diagnosis unit 108 performs the determination of abnormality in the AC current sensor 150 using the first diagnosis unit 1081 (step S30), and when the target current is equal to or larger than the predetermined value (step S10A: Yes), the AC current sensor diagnosis unit 108 performs the determination of abnormality in the AC current sensor 150 using the second diagnosis unit 1082 (step S20). With such a configuration, in the substantially same manner as the first embodiment, in performing the calculation of a voltage command value using a PI control, abnormality in the AC current sensor 150 can be accurately detected regardless of a fundamental frequency of an AC current.

### Fourth Embodiment

Hereinafter, the fourth embodiment of the present invention will be described. In this embodiment, the description is made with respect to an example of a power conversion device that performs determination switching processing between the first diagnosis unit 1081 and the second diagnosis unit 1082 based on an operation condition that differs from the operation condition in the first embodiment and the operation condition in the third embodiment. The description of configurational parts substantially equal to the corresponding configurational parts of the first embodiment will be omitted unless otherwise necessary.

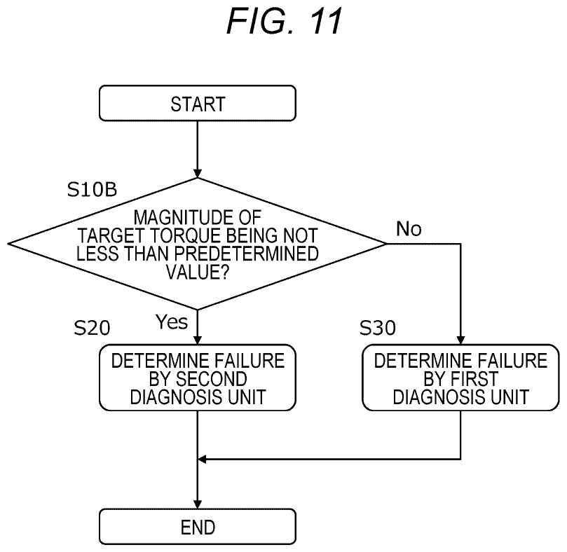

FIG. 11 is a flowchart illustrating an example of determination switching processing between the first diagnosis unit 1081 and the second diagnosis unit 1082 in the fourth embodiment of the present invention.

In step S10B, the AC current sensor diagnosis unit 108 determines whether or not a magnitude of a target torque for the motor 20 is equal to or larger than a predetermined value. In this embodiment, for example, information on a target torque outputted from the electronic control device 3 is acquired, and the determination in step S10B can be performed using information on this target torque.

In the determination performed in step S10B, in a case where it is determined that a magnitude of a target torque is equal to or larger than a predetermined value, processing advances to step S20, and abnormality determination is performed by the second diagnosis unit 1082. On the other hand, when it is determined in step S10B that the magnitude of the target torque is smaller than the predetermined value, the processing advances to step S30, and the abnormality determination is performed by the first diagnosis unit 1081. When the abnormality determination is performed by either one of the first diagnosis unit 1081 or the second diagnosis unit 1082 in either one of step S20 or step S30, the processing illustrated in the flowchart in FIG. 11 ends.

As described in the third embodiment, in a case where an actual current deviates from a target current by a certain amount due to the occurrence of a failure in the AC current sensor 150, when the target current is small, the abnormality determination based on a two-phase voltage command value that the first diagnosis unit 1081 performs can more easily obtain an accurate determination result. Conversely, when the target current is large, the abnormality determination based on the two-phase current detection value that the second diagnosis unit 1082 performs can more easily obtain an accurate determination result. It must be noted that there is a tendency that the larger a target torque, the larger a target current becomes. Accordingly, even when a failure determination method is switched to the method that uses a target torque in place of a target current as in the case of this embodiment, the occurrence of a failure in the AC current sensor 150 can be accurately determined.

According to the fourth embodiment of the present invention described above, when a target torque is smaller than a predetermined value (step S10B: No), the AC current sensor diagnosis unit 108 performs the determination of abnormality in the AC current sensor 150 using the first diagnosis unit 1081 (step S30), and when the target torque is equal to or larger than the predetermined value (step S10B: Yes), the AC current sensor diagnosis unit 108 performs the determination of abnormality in the AC current sensor 150 using the second diagnosis unit 1082 (step S20). With such a configuration, in the substantially same manner as the first embodiment, in performing the calculation of a voltage command value using a PI control, abnormality in the AC current sensor 150 can be accurately detected regardless of a fundamental frequency of an AC current.

In each of the first to fourth embodiments described above, with respect to the number of the predetermined values of the fundamental frequency, the number of the predetermined values of the target current and the number of the predetermined values of the target torque of the AC current for performing switching of the failure determination method of the AC current sensor 150, only one predetermined value is used respectively. However, the number of the predetermined values may be plural. For example, in the case where a first predetermined value and a second predetermined value (the first predetermined value <the second predetermined value) are used, a range where both the first diagnosis unit 1081 and the second diagnosis unit 1082 are used may be set such that when the value of the fundamental frequency, the value of the target current or the value of the target torque is less than the first predetermined value, the abnormality determination is performed by only the first diagnosis unit 1081, when the predetermined value is equal to or larger than the first predetermined value and less than the second predetermined value, the abnormality determination is performed by both the first diagnosis unit 1081 and the second diagnosis unit 1082, and when the predetermined value is equal to or larger than the second predetermined value, the abnormality determination is performed by only the second diagnosis unit 1082.

In each of the embodiments described above, in particular, the configuration where the AC current sensor 150 is installed only in two phases is focused. However, the method of diagnosing the AC current sensor 150 according to the present invention can also be applied to the configuration where the AC current sensor 150 is installed in three phases.

The present invention is not limited to the above-described embodiments, and includes various modifications of these embodiments. For example, the above-described respective embodiments have been described in detail for facilitating the understanding of the present invention. However, the embodiment is not necessarily limited to the power conversion device or the drive device that includes all configurations described above. A part of the configuration of one embodiment can be replaced with the configuration of another embodiment, and the configuration of another embodiment can be added to the configuration of one embodiment. Further, with respect to parts of the configurations of the respective embodiments, the addition, the deletion and the replacement of other configurations can be made. In addition, the above-described configurations, functions, processing units, processing means, and the like may be partially or entirely realized by hardware, for example, by designing with an integrated circuit. In addition, the above-described configurations, functions, and the like may be realized by software using a processor that interprets and executes programs for realizing the respective functions. Information such as programs, tables, and files for realizing the respective functions can be stored in a storage device such as a memory, a recording medium such as a hard disk, or a solid state drive (SSD), or a recording medium such as an IC card, an SD card, or a DVD.

It must be noted that the present invention is not limited to the above-described embodiments, and various modifications can be made without departing from the gist of the present invention.

### REFERENCE SIGNS LIST

1 drive device
2 DC power supply
3 electronic control device
4 failure notification device
10 power conversion device
20 motor
100 control circuit
101 motor speed calculation unit
102 1-phase current calculation unit
103 target current calculation unit
104 voltage command calculation unit
105 PWM signal generation unit
106 voltage command 2-phase conversion unit
107 current 2-phase conversion unit
108 AC current sensor diagnosis unit
120 driver circuit
130 power conversion circuit
140 voltage sensor
150 AC current sensor
1081 first diagnosis unit
1082 second diagnosis unit

1. A power conversion device that converts DC power into three-phase AC power and outputs the three-phase AC power, the power conversion device comprising:
an AC current sensor that detects current values of 2 phases among three-phase AC currents generated by the three-phase AC power;
a target current calculation unit that calculates a target current based on a target torque;
a voltage command calculation unit that calculates a voltage command value based on the target current and a detection value of the AC current sensor; and
an AC current sensor diagnosis unit that determines an abnormality of the AC current sensor based on a detection value of the AC current sensor,
wherein the AC current sensor diagnosis unit includes: a first diagnosis unit that determines the abnormality based on a two-phase voltage command value obtained by converting the voltage command value into a value in a two-phase orthogonal coordinate system using any output phase as a reference; and a second diagnosis unit that determines the abnormality based on a two-phase current detection value obtained by converting a detection value of the AC current sensor into a value in the two-phase orthogonal coordinate system, and
the AC current sensor diagnosis unit performs switching of determination between determination of the abnormality by the first diagnosis unit and determination of the abnormality by the second diagnosis unit corresponding to an operation condition of the power conversion device.

2. The power conversion device according to claim 1, wherein the AC current sensor diagnosis unit determines the abnormality by the first diagnosis unit when a fundamental frequency of the three-phase AC current is smaller than a predetermined value, and determines the abnormality by the second diagnosis unit when the fundamental frequency of the three-phase AC current is equal to or larger than the predetermined value.

3. The power conversion device according to claim 1, wherein the AC current sensor diagnosis unit determines the abnormality by the first diagnosis unit when the target current is smaller than a predetermined value, and determines the abnormality by the second diagnosis unit when the target current is larger than the predetermined value.

4. The power conversion device according to claim 1, wherein the AC current sensor diagnosis unit determines the abnormality by the first diagnosis unit when the target torque is smaller than a predetermined value, and determines the abnormality by the second diagnosis unit when the target torque is larger than the predetermined value.

5. The power conversion device according to claim 1, wherein the first diagnosis unit determines that an abnormality occurred in the AC current sensor when a change amount of a magnitude of the two-phase voltage command value is equal to or larger than a predetermined threshold.

6. The power conversion device according to claim 1, wherein the first diagnosis unit acquires a target value for the two-phase voltage command, and determines that the AC current sensor is abnormal when a differential between the target value and the actual two-phase voltage command value is equal to or larger than a predetermined threshold.

7. The power conversion device according to claim 1, wherein the second diagnosis unit determines that the AC current sensor is abnormal when a change amount of a magnitude of the two-phase current detection value is equal to or larger than a predetermined threshold.

8. The power conversion device according to claim 1, wherein the second diagnosis unit acquires a target value for the two-phase current detection value, and determines that the AC current sensor is abnormal when a differential between the target value and the actual two-phase current detection value is equal to or larger than a predetermined threshold.

9. A drive device comprising:
the power conversion device according to claim 1; and
an AC motor driven by a three-phase AC current outputted from the power conversion device,
wherein the drive device drives a vehicle to travel using a driving force of the AC motor.
